(19) United States
(12) Patent Application Publication
(10) Pub. No.: US 2007/0015092 A1
(43) Pub. Date: Jan. 18, 2007

(54) Color forming compositions

(76) Inventors: Makarand P. Gore, Corvallis, OR (US); Jayprakash Bhatt, Corvallis, OR (US); Vladek P. Kasperchik, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/180,410

(22) Filed: Jul. 13, 2005

(51) Int. Cl. B41M 5/20

(52) U.S. Cl. 430/332; 503/216

(57) ABSTRACT

A radiation image-able material includes a base matrix material, a thermally activated marking material, and at least one colorant. A light activated contains (a) at least one color-forming compd. and (b) at least one color developer of the formula R1SO₂NHXNHABR2 [R1=(substituted) Ph, naphthyl, or C₁₋₂₀ alkyl; X═CNH, CS, or CO; A=(substituted) phenylene, naphthylene, or C₁₋₁₂ alkylene or a divalent heterocyclic group; B═OSO₂, SO₂O, NHSO₂, SO₂NH, SSO₂, OCO, OCONH, NHCO, NHCO₂, SCONH, SCSNH, CONHSO₂, OCONHSO₂, NH═CH, CONHCO, S, CO, O, SO₂NHCO, OCO₂, or OPO(OR2)₂; and R2=(substituted) aryl, benzyl, or C₁₋₂₀ alkyl, with the proviso that if B is not OSO₂, R2 is (substituted) Ph, naphthyl, or C₁₋₈ alkyl and if B is O, R2 is not alkyl].

### BACKGROUND

Compositions that produce a color change upon exposure to energy in the form of light or heat are of great interest in generating images on a variety of substrates. For example, data storage media provide a convenient way to store large amounts of data in stable and mobile formats. For example, optical discs, such as compact discs or other discs, allow a user to store relatively large amounts of data in a single place. Data on such discs often includes entertainment, such as music and/or images, as well as other types of data. In the past, consumer devices were read only. In other words, devices were configured to read the data stored on such devices and the devices were not configured to store additional data thereon. Data was frequently placed on the disc by way of a large commercial machine that burned the data onto the disc. In order to identify the contents of the disc, commercial labels were frequently printed onto the disc by way of screen printing or other similar methods.

Recent efforts have been directed to providing disc burning or writing capabilities to consumers. Such efforts include the use of drives that are configured to burn recordable compact discs, rewritable compact discs, recordable digital video discs, and/or rewritable digital video discs to name a few. These drives provide a convenient way for users to record relatively large amounts of data that may then be easily transferred or used in other devices.

The data storage mediums, such as compact discs or other such mediums, frequently have two sides: a data side and a label side. The data side contains data that is burned into the medium. The label side is frequently a background on which the user hand writes information thereon to identify the disc. Accordingly, it may be difficult and relatively time consuming to provide high-quality hand written labels.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a schematic view of a media processing system according to one exemplary embodiment.

FIG. 2 is a flowchart illustrating a method of forming a composition according to one exemplary embodiment.

Throughout the drawings, identical reference numbers designate similar, but not necessarily identical, elements.

### DETAILED DESCRIPTION

The present compositions and methods provide for the preparation of a colorable and/or surface-treated radiation image-able substrate. In particular, compounds containing —SO₂—NH—substructure, such as sulfonyl amides or sulfonyl ureas, are used as developers in conjunction with colorformer materials such as fluoran leuco dyes and a radiation absorber. The default marking material described herein includes a base matrix material and a light-activated marking composition.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Schematic View of a Media System

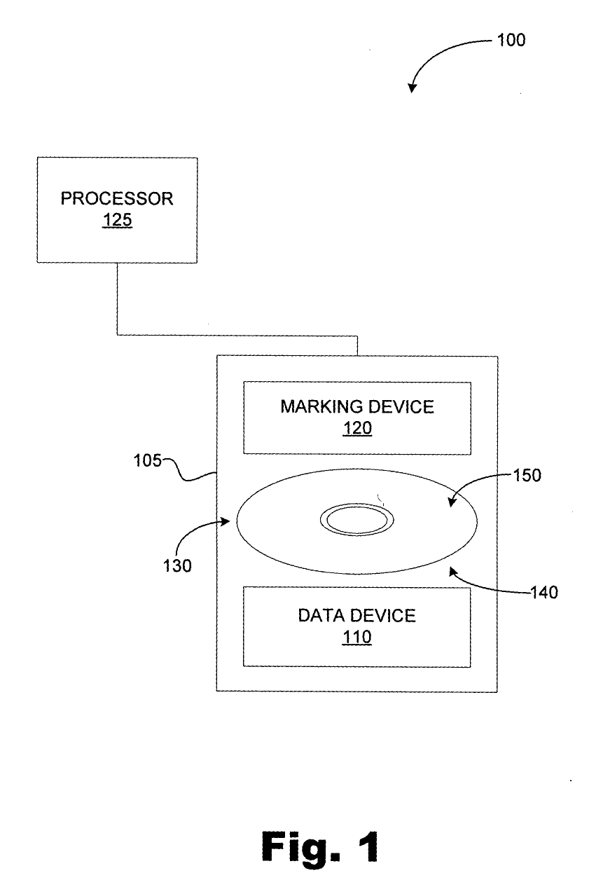

FIG. 1 illustrates a schematic view of a media processing system (100). As will be described in more detail below, the media processing system (100) allows a user, among other things, to expose a radiation image-able surface with coatings of this invention, register an image and use the imaged object for a variety of purposes. For example, users insert a radiation image-able data storage medium (radiation image-able disc) into the system to have data stored on the data storage medium and to have a graphic image selectively established thereon.

Exemplary radiation image-able discs encompass audio, video, multi-media, and/or software disks that are machine readable in a CD and/or DVD drive, or the like. Examples of radiation image-able disc formats include writeable, recordable, and rewriteable disks such as DVD, DVD-R, DVD-RW, DVD+R, DVD+RW, DVD-RAM, CD, CD-ROM, CD-R, CD-RW, and the like. Other like formats may also be included, such as similar formats and formats to be developed in the future.

The media processing system shown includes a housing (105) that houses a data device (110) and a marking device (120) coupled to a processor (125). The operation of both the data device (110) and the marking device (120) may be controlled by the processor (125). The media processing system (100) also includes hardware for placing a radiation image-able data storage medium (radiation image-able disc) (130) in a position to be read by the data device (110) and/or marked by the marking device (120). The operation of the hardware may also be controlled by the processor (125).

The processor (125) shown is separate from the media processing system (100), according to one exemplary embodiment. Exemplary processors (125) may include, without limitation, a computer or other such device. The processor (125) may have software or other drivers residing thereon configured to control the operation of the data device and the marking device to selectively read and/or write data to the data storage medium (130). Those of skill in the art will understand that any suitable processor may be used, including a processor configured to reside on the media processing system.

As introduced, the data device (110) and the marking device (120) are each configured to interact with a radiation image-able data storage medium (130). In particular, the exemplary radiation image-able disc (130) includes first and second opposing sides (140, 150). The first side (140) has a data surface formed thereon that is configured to store data while the second side (150) has a radiation image-able surface formed thereon.

With respect to the first side (140), the data device (110) may be configured to read data stored on the data device (110) and/or to store data on the radiation image-able disc (130). As used herein, “data” is typically used with respect to the present disclosure to include the non-graphic information contained on the radiation image-able disc that is digitally or otherwise embedded therein. Data can include audio information, video information, photographic information, software information, and the like. Alternatively, the term “data” may also be used to describe the information a computer or other processor uses to draw from in order to form a graphic display on the radiation image-able surface of the second side (150).

As will be discussed in more detail below, the marking device (120) is configured to selectively apply electromagnetic radiation to the radiation image-able surface to thereby form a graphic display thereon. As used herein, “graphic display” can include any visible character or image found on an optical disk. Typically, the graphic display is found prominently on one side of the optical disk, though this is not always the case. By selectively marking the surface of the second side (150), the marking device (120) may thus be configured to form a “label” on the second side. In particular, the radiation image-able surface may include color-forming compositions that react to the electromagnetic radiation. Several exemplary color-forming compositions will be discussed in more detail below.

Method of Forming Color Forming Composition

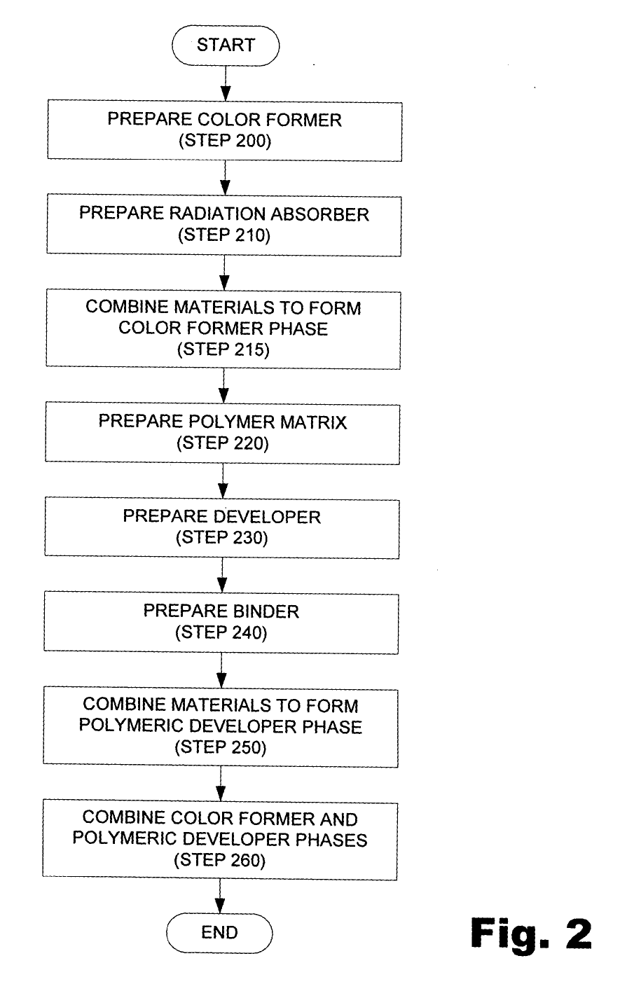

FIG. 2 illustrates a method of forming a color-forming composition according to one exemplary embodiment. As illustrated, the method includes the preparation of a color former (step 200). As used herein, the term “color former” refers to any composition that changes color upon application of energy. Color formers are typically leuco dyes, photochromic dyes, or the like. For example, the color former may include leuco dyes, such as fluoran, isobenzofuran, and phthalide-type leuco dyes. The term “color former” does not infer that color is generated from scratch, as it includes materials that can change in color, as well as materials that can become colored from a colorless or more transparent state or a different color.

The method can also include the preparation of a radiation absorber (step 210). According to one exemplary embodiment, the color former, radiation absorber, and other ingredients may be mixed together to form a color former phase (step 215). As used herein, “radiation absorber” refers generally to a radiation-sensitive agent that can generate heat or otherwise transfer energy to surrounding molecules upon exposure to radiation at a specific wavelength or range of wavelengths. The radiation absorber may be selected based on the wavelength or range of wavelengths produced by a desired device. When admixed with and/or in thermal contact with a leuco dye and/or a corresponding developer, a radiation absorber can be present in sufficient quantity so as to produce ample energy to at least partially develop the color former.

For purposes of the present system and method, the term “color” or “colored” refers to absorbance and reflectance properties that are preferably visible, including properties that result in black, white, or traditional color appearance. In other words, the terms “color” or “colored” includes black, white, and traditional colors, as well as other visual properties, e.g., pearlescence, reflectivity, translucence, transparency, etc.

As used herein, “thermal contact” refers to the spatial relationship between a radiation absorber and other members of the color forming composition (including the color former and/or the developer). For example, when a radiation absorber is heated by interaction with electromagnetic radiation, the energy generated by the absorber should be sufficient to cause the color former or color forming composition to darken, lighten, become colored, or otherwise change in visible perception, such as through a chemical reaction.

Thermal contact can include close proximity between a radiation absorber and other members of the color forming composition, which allows for energy transfer from the absorber toward the color former and/or developer. Thermal contact can also include actual contact between a radiation absorber and one or more other members of the color forming composition, such as in immediately adjacent layers, or in an admixture including some or all of the other constituents.

Further, the radiation absorber can be present within a color former phase, within a polymeric developer phase, and/or layered with respect to the color former/polymeric developer dispersion. For example, the radiation absorber may be combined with the color former to create a color former phase and/or combined with a polymeric developer to form a developer phase and/or may be layered between a color former phase and a developer phase.

The present method, which includes the preparation of at least a polymer matrix (step 220), a developer (step 230), and a binder (step 240), may be combined together with other materials as desired, to form the polymer developer phase (step 250). In one embodiment, the polymeric developer phase can include polymeric developer matrix with a developer that has sulfonylamide functionality as substructure dispersed or dissolved therein. For example, the sulfonyl amide compounds have —SO₂—NH—, and as another case —SO₂—NH—CO—NH— substructure contained in the molecular structure. Thereafter, the polymeric phases containing developer and color former phase are combined (step 260). Suitable color formers, radiation absorbers, developers, polymeric matrices, and stabilizers will now be discussed in more detail.

Polymeric Phase Containing Developer

Exemplary color forming compositions include a polymer developer phase, which comprises at least a polymer matrix and a developer. In one embodiment, the developer phase includes a sulfonamide developer. As mentioned above, a color former phase is finely dispersed within the polymeric phase containing developer. Exemplary color former phases will be discussed in more detail below. Various polymer matrix materials can influence the development properties of the color forming composition such as development speed, light stability, and wavelengths that can be used to develop the color forming composition.

The polymeric developer phase also includes a developer. Suitable developers include sulfonamides, such as sulfonyl urea. The use of sulfonamides may provide excellent image stability due to unique complexes and structures formed upon reaction with certain color formers, such as fluoran color formers, resulting in stable color and images. Other suitable sulfonamide developers include, without limitation Benzenesulfonamide, N,N′-[methylenebis(4,1-phenyleneiminocarbonyl)] 4,4′-Bis(p-toluenesulfonylaminocarbonylamino) diphenylmethane; 4,4′Bis(p toluenesulfonylaminocarboxylamino) diphenylmethane; 4,4′-Bis(p-tolylsulfonylureido)diphenylmethane; BTUM N-(p-toluenesulfonyl)-N′-(3-p-toluenesulfonyl-oxy-phenyl)urea, 4,4′bis[(4-methyl-3-phenoxycarbonylaminophenyl)ureido]diphenyl sulfone, a color developer, greater than one urea derive. R1SO₂NHCONHC(:X)NHCOR2 (R1, R2=arom. group which may be substituted for more than one selected from lower alkyls and halos; X═O, S), 4,4′-bis[(4-methyl-3-phenoxycarbonylaminophenyl)ureido]diphenyl sulfone, 4,4′-bis(N-p-tolylsulfonylaminocarbonylamino)diphenylmethane, N-p-tolylsulfonyl-N′-3-(p-tolylsulfonyloxy)phenyl urea, 4,4′-bis[(4-methyl-3-phenoxycarbonylaminophenyl)ureido]diphenyl sulfone, 2,2-bis[4-(4-methyl-3-phenylureidophenyl)aminocarbonyloxyphenyl]propane, and 4-(p-tolylsulfonylamino)phenol. Other suitable developers may be characterized by Formulas I-IV.

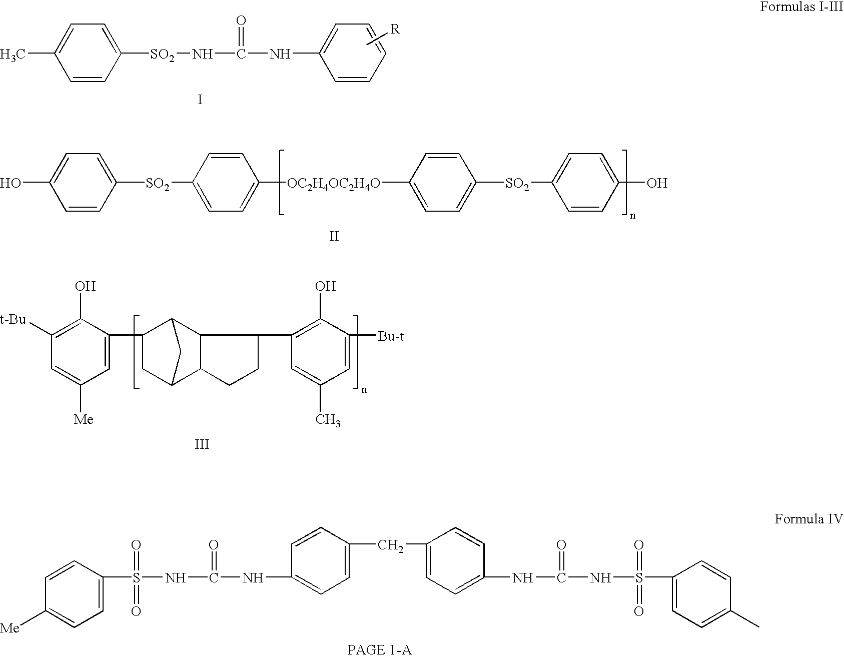

Acceptable polymer matrix materials can include, by way of example, UV curable polymers such as acrylate derivatives, oligomers, and monomers. These materials are often included or assembled as part of a photo package. A photo package can include a light absorbing species that initiates reactions for curing of a lacquer. Such light absorbing species can be sensitized for curing, and include, by way of example, benzophenone derivatives. Other examples of photoinitiators for free radical polymerization monomers and pre-polymers can include, but are not limited to, thioxanethone derivatives, anthraquinone derivatives, acetophenones, and benzoine ethers.

It may be desirable to choose a polymer matrix that is cured by a form of radiation that does not also develop the color former or otherwise decrease the stability of the color forming composition at the energy input and flux necessary to cure the coatings. Thus, the polymer matrix can be curable at a curing wavelength that is other than the developing wavelength of the color forming composition. For example, in one embodiment, the curing wavelength can be in the ultraviolet (UV) range and the developing wavelength can be in the infrared range.

Alternatively, the curing wavelength and the developing wavelength can both be in the UV range, but may be different enough such that the curing wavelength does not substantially cause undesired development of the color forming composition. For example, selecting a first UV wavelength of 405 nm for the developing wavelength and a second UV wavelength of about 200 nm to about 380 nm for the curing wavelength of the polymer matrix may provide an effective system for curing the polymer without prematurely developing the color forming composition.

Radiation curable polymers can include certain photoinitiators for initiating curing upon exposure to radiation. Suitable photoinitiators should also have a light absorption band that is not obscured by the absorption band of the radiation absorber (as will be discussed hereinafter), otherwise the radiation absorber can interfere with photoinitiator activation, and thus, prevent proper curing of the coating.

Therefore, in one practical embodiment of the present exemplary system and method, a photoinitiator light absorption band can lie within the UV region, e.g., from about 200 nm to about 380 nm, and the absorber band can lie outside of this range, e.g., from about 390 to about 1100 nm. In practice, the lower end of the radiation absorber band would likely overlap with the UV wavelength range used for polymer curing. However, a working system design is possible because the energy flux required for development of a color former is about 10 times higher than needed for initiation of polymer curing. In yet another embodiment, the absorber has a dual function; one of sensitization of UV cure under cure conditions (relatively low energy flux), and another of providing energy for marking during the marking function. This may be possible because the energy flux during cure is typically an order of magnitude lower than needed for producing a mark.

Radiation curable polymers can also include certain photoinitiators for initiating curing upon exposure to radiation. Suitable photoinitiators may also have a light absorption band that is not obscured by the absorption band of the radiation absorber (as will be discussed hereinafter), otherwise the radiation absorber can interfere with photoinitiator activation, and thus, prevent proper curing of the coating. Therefore, in one exemplary embodiment, a photoinitiator light absorption band can lie within the UV region, e.g., from about 200 nm to about 380 nm, and the absorber band can lie outside of this range, e.g., from about 390 to about 1100 nm.

In practice, the lower end of the radiation absorber band may overlap with the UV wavelength range used for polymer curing. However, a working system design is possible because the energy flux required for development of a color former is about 10 times higher than needed for initiation of polymer curing.

In yet another embodiment, the radiation absorber has a dual function; one of sensitization of UV cure under cure conditions (relatively low energy flux), and another of providing energy for marking during the marking function. This may be possible because the energy flux during cure is typically an order of magnitude lower than needed for producing a mark.

Polymer matrix materials based on cationic polymerization resins can include photo-initiators including aromatic diazonium salts, aromatic halonium salts, aromatic sulfonium salts, and metallocene compounds. Additional examples of curing agents are α-aminoketones, α-hydroxyketones, phosphineoxides available from Ciba-Geigy under the names of Irgacure and Darocure, and sensitizers such as 2-isopropyl-thioxanthone.

One specific example of a suitable polymer matrix is Nor-Cote CDG-1000 (a mixture of UV curable acrylate monomers and oligomers), which contains a photoinitiator (hydroxy ketone) and organic solvent acrylates, e.g., methyl methacrylate, hexyl methacrylate, beta-phenoxy ethyl acrylate, and hexamethylene acrylate, available from Nor-Cote. Other suitable components for polymer matrix materials can include, but are not limited to, acrylated polyester oligomers, such as CN293 and CN294 as well as CN-292 (low viscosity polyester acrylate oligomer), SR-351 (trimethylolpropane triacrylate), SR-395(isodecyl acrylate), and SR-256(2(2-ethoxyethoxy) ethyl acrylate), all of which are available from Sartomer Co.

Additionally, binders can be included as part of the polymer matrix. Suitable binders can include, but are not limited to, polymeric materials such as polyacrylate from monomers and oligomers, polyvinyl alcohols, polyvinyl pyrrolidines, polyethylenes, polyphenols or polyphenolic esters, polyurethanes, acrylic polymers, and mixtures thereof. For example, the following binders can be used in the color forming composition of the present system and method: cellulose acetate butyrate, ethyl acetate butyrate, polymethyl methacrylate, polyvinyl butyral, and mixtures thereof.

Accordingly, the polymer matrix of the polymeric developer phase can be a single polymer or a group of polymers. The polymers can act as a solute of the polymeric developer phase, or can be dissolved or dispersed in another material, such as a solvent or another component of the phase. If multiple polymers are present, the polymers can be blended, crosslinked, or otherwise combined. In one embodiment, the polymer matrix can include a radiation curable polymer or system of polymers, olligomers, and/or monomers, etc. Though the polymer matrix is integral to the polymeric developer phase, it can be present in any of a number of forms.

The polymeric developer phase also includes a developer, which depending on the color former used in the color former phase, can be a reducing agent. Typical developers that can be used include any of a variety of acids. For example, the developer can be a sulfonamide compound. Further, these developers can be readily dissolvable in the polymer matrix under the conditions with which the dispersion is to be prepared and/or stored. A non-limiting example of suitable developer includes sulfonyl urea.

Typically, the developer will be present in the color forming composition as a whole at from 1 wt % to about 40 wt %. Because the developer is present in the polymeric developer phase, it will typically remain predominantly in this phase until the polymeric developer phase becomes at least partially molten and the color former phase begins to melt with the polymeric developer phase. In other words, by including the developer in the polymeric developer phase, the developer may be kept substantially separated from the color former phase until the composition is heated.

Upon being heated with energy due to contact with a radiation absorber, the polymeric developer phase can become molten and the particles of the color former phase become melted therein. Upon melting, the developer contacts the color former, thereby causing a modification in color of the color former, e.g., leuco dye.

In addition to the polymer matrix and the developer, other optional ingredients can also be present in the polymeric developer phase. For example, in embodiments, such as where fluoran-type leuco dyes (or other similar color formers) are used in the color former phase, preparation of the polymeric developer phase can also include the preparation of a stabilizer capable of stabilizing the fluoran leuco dye after melting the two phases together (step 240). More specifically, when the leuco dye is in its post-development colored state. Specifically, the post-development colored state of a fluoran leuco dye can have an open lactone ring. Image fade that can occur with many Leuco-dye-based thermochromic coatings can be related to leuco dye crystallization from after an amorphous melt.

For the above reasons, an aromatic species capable of stabilizing the post-development leuco dye in the amorphous phase can provide image stabilization. Exemplary aromatic stabilizers that can be used to stabilize post-development leuco dyes, i.e. after melt, include, but are not limited to zinc salts such as zinc stearate, zinc hexanoate, zinc salicylate, and zinc acetate; carboxylates such as calcium monobutylphthalate and sulfonyl urea derivatives; and phenolic compounds such as bisphenol-A, sulfonyl diphenol, TG-SA, and zinc or calcium salts thereof. The color forming compositions may include from about 1 wt % to about 40 wt % of this or another type of stabilizer. Preferably, the stabilizer can be present at from about 2 wt % to about 20 wt % of the total composition.

Polymer matrix materials based on cationic polymerization resins can comprise photo-initiators including aromatic diazonium salts, aromatic halonium salts, aromatic sulfonium salts, and metallocene compounds. Additional examples of curing agents are α-aminoketones, α-hydroxyketones, phosphineoxides available from Ciba-Geigy under the names of Irgacure and Darocure, and sensitizers such as 2-isopropyl-thioxanthone. One specific example of a suitable polymer matrix is Nor-Cote CDG-1 000 (a mixture of UV curable acrylate monomers and oligomers) that contains a photoinitiator (hydroxy ketone) and organic solvent acrylates, e.g., methyl methacrylate, hexyl methacrylate, beta-phenoxy ethyl acrylate, and hexamethylene acrylate, available form Nor-Cote. Other suitable components for polymer matrix materials can include, but are not limited to, acrylated polyester oligomers, such as CN293 and CN294 as well as CN-292 (low viscosity polyester acrylate oligomer), SR-351 (trimethylolpropane triacrylate), SR-395(isodecyl acrylate), and SR-256(2(2-ethoxyethoxy) ethyl acrylate), all of which are available from Sartomer Co.

Additionally, binders can be included as part of the polymer matrix. Suitable binders can include, but are not limited to, polymeric materials such as polyacrylate from monomers and oligomers, polyvinyl alcohols, polyvinyl pyrrolidines, polyethylenes, polyphenols or polyphenolic esters, polyurethanes, acrylic polymers, and mixtures thereof. For example, the following binders can be used in the color forming composition of the present system and method: cellulose acetate butyrate, ethyl acetate butyrate, polymethyl methacrylate, polyvinyl butyral, and mixtures thereof.

In short, the polymer matrix of the polymeric developer phase can be a single polymer or a group of polymers. The polymers can act as a solute of the polymeric developer phase, or can be dissolved or dispersed in another material, such as a solvent or another component of the phase. If multiple polymers are present, the polymers can be blended, crosslinked, or otherwise combined. In one embodiment, the polymer matrix can include a radiation curable polymer or system of polymers, oligomers, and/or monomers, etc. Though the polymer matrix is integral to the polymeric developer phase, it can be present in any of a number of forms.

Color Formers

Color forming compositions of the present system and method can include a color former phase dispersed within the polymeric developer phase discussed above. Typically, the color former phase is substantially insoluble in the polymer matrix, exists distinct from the polymer matrix at room temperature, and is finely dispersed within the polymer matrix. The dispersion can be formed using color former particles prepared by any known method such as mixing, rolling, milling, or the like. In most cases, it can be desirable to uniformly disperse the color former phase throughout the polymer matrix. Dispersing the color former phase within the polymer matrix allows for increased contact of the leuco dye with developer material and/or other energy transfer materials, which are discussed below in more detail. Further, a dispersion of color former phase within the polymer matrix can be formed as a single composition, e.g., a paste, which can then be coated on a substrate in a single step. The volume of color former phase dispersed within the polymer matrix can vary considerably depending on the concentration and type of color former used, as well as a number of other factors such as desired development speed, desired color intensity of developed color former, and the like. The color former phase volume percent in the polymer matrix can be from about 1% to about 50%, and in some cases from about 10% to about 30%.

Typical lasers used for marking optical disks, for example, include those that range in wavelength from about 200 nm to about 1200 nm, i.e., 0.2 μm to about 1.2 μm. By providing particles that are of the same order or smaller of magnitude as the wavelength of the laser that is used, light scattering is minimized or removed. In other words, light scattering caused by interaction of laser radiation with larger color former phase particles can result in partial reflection of the laser beam, causing energy loss.

The color former phase can include a variety of materials, including at least one color former. Exemplary color formers include leuco dyes, photochromic dyes, or the like. Fluoran leuco dyes have been shown to be particularly practical in accordance with embodiments of the present system and method, though other leuco dyes can also be used. For example, the leuco dye can be a fluoran, phthalide, aminotriarylmethane, isobenzofuranone, or mixture thereof. Suitable leuco dyes include, but are not limited to, fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(phydroxyphenyl)-4,5-diphenylimidazoles, indanones, leuco indamines, hydrozines, leuco indigoid dyes, amino-2,3-dihydroanthraquinones, tetrahalo-p,p′-biphenols, 2(phydroxyphenyl)-4,5-diphenylimidazoles, phenethylanilines, phthalocyanine precursors (such as those available from Sitaram Chemicals, India), and mixtures thereof.

As mentioned, fluoran based leuco dyes have proven useful for incorporation into the color forming compositions of the present system and method. Several non-limiting examples of suitable fluoran based leuco dyes include 3-diethylamino-6-methyl-7-anilinofluorane, 3-(N-ethyl-ptoluidino)-6-methyl-7-anilinofluorane, 3-(N-ethyl-N-isoamylamino)-6-methyl-7-anilinofluorane, 3-diethylamino-6-methyl-7-(o,p-dimethylanilino)fluorane, 3-pyrrolidino-6-methyl-7-anilinofluorane, 3-piperidino-6-methyl-7-anilinofluorane, 3-(N-cyclohexyl-N-methylamino)-6-methyl-7-anilinofluorane, 3-diethylamino-7-(m-trifluoromethylanilino) fluorane, 3-dibutylamino-6-methyl-7-anilinofluorane, 3-diethylamino-6-chloro-7-anilinofluorane, 3-dibutylamino-7-(o-chloroanilino)fluorane, 3-diethylamino-7-(ochloroanilino) fluorane, 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofuranone,4,5,6,7-tetrachloro-3,3-bis[2-[4-(dimethylamino)phenyl]-2-(4-methoxyphenyl)ethenyl], 2-anilino-3-methyl-6-(N-ethyl-N-isoamylamino)fluorane (S-205 available from Nagase Co., Ltd), and mixtures thereof. Aminotriarylmethane leuco dyes can also be used in the present system and method such as tris (N,N-dimethylaminophenyl) methane (LCV); deutero-tris (N,N-dimethylaminophenyl) methane (D-LCV); tris (N,N-diethylaminophenyl) methane (LECV); deutero-tris (4-diethylaminolphenyl) methane (D-LECV); tris(N,N-di-n-propylaminophenyl) methane (LPCV); tris(N,N-din-butylaminophenyl) methane (LBCV); bis(4-diethylaminophenyl)-(4-diethylamino-2-methyl-phenyl) methane (LV-1); bis(4-diethylamino-2-methylphenyl)-(4-diethylamino-phenyl) methane (LV-2); tris(4-diethylamino-2-methylphenyl) methane (LV-3); bis(4-diethylamino-2-methylphenyl)(3,4-dimethoxyphenyl) methane (LB-8); aminotriarylmethane leuco dyes having different alkyl substituents bonded to the amino moieties wherein each alkyl group is independently selected from C1-C4 alkyl; and aminotriaryl methane leuco dyes with any of the preceding named structures that are further substituted with one or more alkyl groups on the aryl rings wherein the latter alkyl groups are independently selected from C1-C3 alkyl. Other color formers can also be used in connection with the present exemplary system and method and are known to those skilled in the art. Another class of dyes is the phthalide color formers such as crystal violet lactone (CAS #1552-42-7) available from the Nagase Corporation, and Divinyl phthtalide dyes such as NIR black 78, CAS #113915-68-7, available from the Nagase Corporation, containing isobenzofuranone substructure.

A more detailed discussion of some of these types of leuco dyes can be found in U.S. Pat. Nos. 3,658,543 and 6,251,571, each of which are hereby incorporated by reference in their entireties. Examples are found in Chemistry and Applications of Leuco Dyes, Muthyala, Ramaiha, ed.; Plenum Press, New York, London; ISBN: 0-30645459-9, which is incorporated herein by reference.

Typically, the leuco dye can be present in color forming compositions of the present system and method at from about 1 wt % to about 50% wt. Although amounts outside this range can be successfully used, depending on the other components of the composition, amounts from about 15 wt % to about 35 wt % frequently provide adequate results.

In order to reduce development times and increase sensitivity to an applied radiation source, the color former phase can further include a melting aid. Suitable melting aids can have a melting temperature from about 50° C. to about 150° C. and often from about 70° C. to about 120° C. Melting aids are typically crystalline organic solids that can be melted and mixed with a particular color former. For example, most color formers are also available as a solid particulate that is soluble in standard liquid solvents. Thus, the color former and melting aid can be mixed and heated to form a molten mixture. Upon cooling, a color former phase of color former and melting aid is formed that can then be ground into a powder. In some embodiments, the percent of color former and melting aid can be adjusted to minimize the melting temperature of the color former phase without interfering with the development properties of the leuco dye. When used, the melting aid can comprise from about 2 wt % to about 25 wt % of the color former phase.

A number of melting aids can be effectively used in the color forming compositions of the present system and method. Several non-limiting examples of suitable melting aids include m-terphenyl, p-benzyl biphenyl, alpha-napthyl benzylether, 1,2-bis(3,4)dimethylphenyl ethane, and mixtures thereof. Suitable melting aids can also include aromatic hydrocarbons (or their derivatives) that provide good solvent characteristics with the leuco dye and radiation absorbers used in the formulations and methods of the present system and method. In addition to dissolving the color former and radiation absorber, the melting aid can also assist in reducing the melting temperature of the color former and stabilize the color former phase in the amorphous state (or at least slow down recrystallization of the color former phase into individual components). In general, any material having a high solubility and/or miscibility with the color former to form a glass or co-crystalline phase with the dye and alters the melting property of the dye is useful in this process. For example, aromatic hydrocarbons, phenolic ethers, aromatic acid-esters, long chain (C6 or greater) fatty acid esters, polyethylene wax, or the like can also be suitable melting aids. Additional materials can also be included in the color former phase such as, but not limited to, stabilizers, anti-oxidants, non-leuco colorants, radiation absorbers, and the like.

Radiation Absorbers

A radiation absorber can also be included in the color forming compositions of the present system and method. The radiation absorber is typically present as a component that can be used to optimize development of the color forming composition upon exposure to radiation at a predetermined exposure time, energy level, wavelength, etc. The radiation absorber can act as an energy antenna, providing energy to surrounding areas upon interaction with an energy source. As a predetermined amount of energy can be provided by the radiation absorber, matching of the radiation wavelength and intensity to the particular absorber used can be carried out to optimize the system. Optimizing the system includes a process of selecting components of the color forming composition that can result in a rapidly developable composition under a fixed period of exposure to radiation at a specified power. For example, compositions of the present system and method can be optimized for development using at a predetermined wavelength of laser energy, e.g., 405 nm, 650 nm, 780 nm, 980 nm, or 1084 nm, in which the color forming composition exposed to the radiation is developed in less than a predetermined period of time, e.g., less than 100 μsec. However, “optimized” does not necessarily indicate that the color forming composition is developed most rapidly at a specific wavelength, but rather that the composition can be developed within a specified time frame using a given radiation source.

An optimized composition can also indicate an ambient light stability over extended periods of time, i.e., several months to years. Thus, an optimized composition results from a combination of all components of the color forming composition in affecting development characteristics and stability. To illustrate, in formulating the color forming composition of the present system and method, an optimized composition can depend on a variety of factors, since each component can affect the development properties, e.g., time, color intensity, etc.

For example, a color forming composition having a radiation antenna with a maximum absorption of about 780 nm may not develop most rapidly at 780 nm. Other components and the specific formulation can result in an optimized composition at a wavelength that does not correspond to the maximum absorption of the radiation antenna. Thus, the process of formulating an optimized color forming composition can include testing formulations to achieve a desired development time using a specific intensity and wavelength of energy to form an acceptable color change.

The radiation absorber can be configured to be in a heat-conductive relationship with the color formers of the present system and method. For example, the radiation absorber can be included within the color former phase, the polymer matrix, and/or a separate layer. Thus, the radiation absorber can be admixed with or in thermal contact with the color forming composition.

Typically, the radiation absorber can be present in both the color former phase and the polymeric developer phase. In this way, substantially the entire color forming composition in an exposed area can be heated quickly and substantially simultaneously. Alternatively, the radiation absorber can be applied as a separate layer that can be optionally spin-coatable or screen-printable, for example. Consideration can also be given to choosing the radiation absorber such that any light absorbed in the visible range does not adversely affect the graphic display or appearance of the color forming composition either before or after development.

Suitable radiation antennae can be selected from a number of radiation absorbers such as, but not limited to, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures or derivatives thereof. Other suitable antennas can also be used in the present system and method and are known to those skilled in the art and can be found in such references as Infrared Absorbing Dyes, Matsuoka, Masaru, ed., Plenum Press, New York, 1990 (ISBN 0-306-43478-4) and Near-Infrared Dves for High Technology Applications, Daehne, Resch-Genger, Wolfbeis, Kluwer Academic Publishers (ISBN 0-7923-5101-0), both of which are incorporated herein by reference.

Consideration can also be given to choosing the radiation antenna such that any light absorbed in the visible range does not adversely affect the graphic display or appearance of the color forming composition either before or after development. For example, in order to achieve a visible contrast between developed areas and non-imaged or non-developed areas of the coating, the color former can be chosen to form a color that is different than that of the background. Although the specific color formers and antennae discussed herein are typically separate compounds, such activity can also be provided by constituent groups of binders and/or color formers which are incorporated in the activation and/or radiation absorbing action of color formers. These types of color former/radiation absorbers are also considered to be within the scope of the present system and method.

Various radiation antennas can act as an antenna to absorb electromagnetic radiation of specific wavelengths and ranges. Generally, a radiation antenna that has a maximum light absorption at or in the vicinity of the desired development wavelength can be suitable for use in the present system and method. For example, in one aspect of the present system and method, the color forming composition can be optimized within a range for development using infrared radiation having a wavelength from about 720 nm to about 900 nm in one embodiment.

Common CD-burning lasers have a wavelength of about 780 nm and can be adapted for forming images by selectively developing portions of the color forming composition. Radiation antennae which can be suitable for use in the infrared range can include, but are not limited to, polymethyl indoliums, metal complex IR dyes, indocyanine green, polymethine dyes such as pyrimidinetrione-cyclopentylidenes, guaiazulenyl dyes, croconium dyes, cyanine dyes, squarylium dyes, chalcogenopyryloarylidene dyes, metal thiolate complex dyes, bis(chalcogenopyrylo)polymethine dyes, oxyindolizine dyes, bis(aminoaryl)polymethine dyes, indolizine dyes, pyrylium dyes, quinoid dyes, quinone dyes, phthalocyanine dyes, naphthalocyanine dyes, azo dyes, hexafunctional polyester oligomers, heterocyclic compounds, and combinations thereof.

Several specific polymethyl indolium compounds that can be used are available from Aldrich Chemical Company, and include 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate; 2-[2-[2-Chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene]-2-(phenylthio)-1-cyclohexen-1-yl]ethenyl]-3,3-dimethyl-1-propylindolium perchlorate; and mixtures thereof. Alternatively, the radiation antenna can be an inorganic compound, e.g., ferric oxide, carbon black, selenium, or the like. Polymethine dyes or derivatives thereof such as a pyrimidinetrione-cyclopentylidene, squarylium dyes such as guaiazulenyl dyes, croconium dyes, or mixtures thereof can also be used in the present system and method. Suitable pyrimidinetrione-cyclopentylidene infrared antennae include, for example, 2,4,6(1H,3H,5H)-pyrimidinetrione 5-[2,5-bis[(1,3-dihydro-1,1,3-dimethyl-2H-indol-2-ylidene)ethylidene]cyclopentylidene]-1,3-dimethyl-(9Cl)

Further, the radiation antenna can be selected for optimization of the color forming composition in a wavelength range from about 600 nm to about 720 nm, such as about 650 nm. Non-limiting examples of suitable radiation antennae for use in this range of wavelengths can include indocyanine dyes such as 3H-indolium,2-[5-(1,3-dihydro-3,3-dimethyl-1-propyl-2H-indol-2-ylidene)-1,3-pentadienyl]-3,3-dimethyl-1-propyl-,iodide) (λmax=642 nm), 3H-indolium, 1-butyl-2-[5-(1-butyl-1,3-dihydro-3,3-dimethyl-2H-indol-2-ylidene)-1,3-pentadienyl]-3,3-dimethyl-,perchlorate (λmax=642 nm), and phenoxazine derivatives such as phenoxazin-5-ium,3,7-bis(diethylamino)-,perchlorate (λmax=645 nm). Phthalocyanine dyes having a λmax of about the desired development wavelength can also be used, such as silicon 2,3-napthalocyanine bis(trihexylsilyloxide) and matrix soluble derivatives of 2,3-napthalocyanine (both commercially available from Aldrich Chemical); matrix soluble derivatives of silicon phthalocyanine (as described in Rodgers, A. J. et al., 107 J. Phys. Chem. A 3503-3514, May 8, 2003), and matrix soluble derivatives of benzophthalocyanines (as described in Aoudia, Mohamed, 119 J. Am. Chem. Soc. 6029-6039, July 2, 1997); phthalocyanine compounds such as those described in U.S. Pat. Nos. 6,015,896 and 6,025,486, which are each incorporated herein by reference; and Cirrus 715 (a phthalocyanine dye available from Avecia, Manchester, England having a λmax=806 nm).

Laser light having blue and indigo wavelengths from about 300 nm to about 600 nm can be used to develop the color forming compositions. Therefore, color forming compositions may be selected for use in devices that emit wavelengths within this range. Recently developed commercial lasers found in certain DVD and laser disk recording equipment provide for energy at a wavelength of about 405 nm. Thus, the compositions discussed herein using appropriate radiation antennae can be suited for use with components that are already available on the market or are readily modified to accomplish imaging. Radiation antennae which can be useful for optimization in the blue (˜405nm) and indigo wavelengths can include, but are not limited to, aluminum quinoline complexes, porphyrins, porphins, and mixtures or derivatives thereof. Non-limiting specific examples of suitable radiation antenna can include 1-(2-chloro-5-sulfophenyl)-3-methyl4-(4-sulfophenyl)azo-2-pyrazolin-5-one disodium salt (λ max=400 nm); ethyl 7-diethylaminocoumarin-3-carboxylate (λ max =418 nm); 3,3′-diethylthiacyanine ethylsulfate (λ max=424 nm); 3-allyl-5-(3-ethyl-4-methyl-2-thiazolinylidene) rhodanine (λ max=430 nm) (each available from Organica Feinchemie GmbH Wolfen), and mixtures thereof.

Non-limiting specific examples of suitable aluminum quinoline complexes can include tris(8-hydroxyquinolinato)aluminum (CAS 2085-33-8), and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1,2-d]1,3-dithiole, all available from Syntec GmbH.

Non-limiting examples of specific porphyrin and porphyrin derivatives can include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange (CAS 2243-76-7), Methyl Yellow (CAS 60-11-7), 4-phenylazoaniline (CAS 60-09-3), Alcian Yellow (CAS 61968-76-1), available from Aldrich chemical company, and mixtures thereof.

In each of these embodiments, generally, the radiation absorber can be present in the color forming composition as a whole at from about 0.1 wt % to about 5 wt %, and typically, from about 1 wt % to about 2 wt %, although other weight ranges may be desirable depending on the molar absorptivity of the particular radiation absorber.

Accordingly, the present method provides for the formation a color forming composition that includes sulfonyl ureas developers. The use of sulfonyl urea develops may be used with fluoran type leuco dyes to form stable images on an optical storage device. The formation of such images will now be discussed in more detail.

### EXAMPLE 1

a) Preparation of Color Former Particles for Color Former Phase

About 10 g of m-terphenyl (accelerator) was melted in a beaker, and the melt was heated to about 110° C. About 100 g of color former was added in small increments to the melt upon constant stirring. The added color former is a leuco-dye (2′-anilino-3′-methyl-6′-(dibutylamino)fluoran) available from Nagase Corporation, the structure of which is set forth below as Formula V:

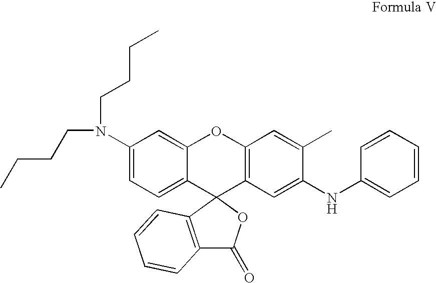

The temperature of the mixture was increased up to about 170° C. tol 80° C. Stirring was continued until complete dissolution of the color former in the melt (usually takes about 10 to 15 minutes) was obtained to form an accelerator/leuco dye solution. Next, about 1.8 g of Cirrus-715 (radiation absorber IR dye) was added to the melt upon constant stirring. Heating and stirring was continued for about two to three additional minutes until the Cirrus-715 was completely dissolved in the melt to form a leuco dye/antenna/accelerator alloy (eutectic). The temperature of the leuco-dye/antenna/accelerator alloy was kept to below about 190° C., and was then poured into a pre-cooled freezer tray lined with aluminum foil. The solidified melt was milled into a coarse powder, and then the pre-milled powder was milled in aqueous dispersion (˜15% solids) using Netzsch Mini-Zeta Bead mill with 1 mm zirconia beads. The milling was stopped when average particle diameter was reduced to a value of about 0.4 μm to about 0.6 μm. The particles in the slurry were then collected and freeze-dried, resulting in color former particles that will become the color former phase.

b) Preparation of the Lacquer-Soluble Cirrus 715 Alloy(m-T/Cirrus 715 Alloy(50150)).

50 g of m-Terphenyl were melted in a beaker. When temperature of the melt reached 140-150° C., 50 g of Cirrus 715 were stirred into the melt. Melt was stirred with temperature maintained around 140-150° C. until complete dissolution of Cirrus 715. Then the melt was cooled down to ambient temperature. The solidified melt was milled into a coarse powder.

c) Preparation of Sulfonyl Urea Developer.

50 g of N-p-Tolylsulfonyl-N′-3-(p-tolylsulfonyloxy)phenylurea, structure—Formula VI) were heated until complete melting.

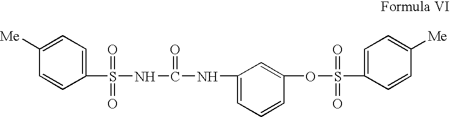

The melt was cooled down to a solid, glassy state and milled in aqueous dispersion (˜15% solids) using Netzsch Mini-Zeta Bead mill with 1.5 mm zirconia beads. The milling was stopped when average particle diameter was reduced to a value of about 1.0 μm to about 1.6 μm. The particles in the slurry were collected and freeze-dried.

d) Preparation of the UV-Curable Developer Phase

About 20 g of the milled sulfonyl urea Developer (step c), 1.38 g of m-Terphenyl/Cirrus 715(50:50) Alloy (step b), 2.15 g of (Bis(2-methyl-4-hydroxy-5-tert-butylphenyl) sulfide (available from TCI America) and 5.86 g of Irgacure-1330 (available from Ciba Specialty Chemicals) were dissolved/dispersed in 45.7 g XP155-049/10 UV-lacquer (available from “Nor-Cote International”) (mixture of UV-curable acrylate monomers and oligomers) to form the lacquer/antenna/developer solution or UV-curable developer phase.

e) Preparation of Color Forming Composition (Fine Dispersion)

A UV-curable paste was prepared by mixing (a) about 25 g of the finely milled color former particles with (d) about 75 g of the UV-curable developer phase. The paste was screen printed onto a substrate at a thickness of approximately about 6 μm to about 8 μm to form an imaging medium including an imaging coating. The coating on the medium was then UV cured by mercury lamp. The resulting coating was transparent with noticeable dark-yellowish hue. Direct marking on the UV cured imaging coating was carried out using a 45 mW laser having a wavelength of about 780 nm. A mark of approximately 20 μm by 45 μm was produced using various durations of energy application from about 40 μsec to about 100 μsec. Upon application of appropriate energy, the color forming composition of the imaging coating changed in color from the yellowish transparent appearance to a black color.

### EXAMPLE 2

The total formulation of Example 2 may be summarized:

| | wt. % |
|---|---|
| Color former Phase | 25.00% |
| *XP155-049/10 Lacquer | 51.52% |
| sulfonyl urea Developer/NIR Dye Alloy | 12.88% |
| m-T/Cirrus 715 Alloy(50/50) | 1.55% |
| (Bis(2-methyl-4-hydroxy-5-tert-butylphenyl) sulfide | 2.43% |
| Irgacure-1300 | 6.62% |

The Color former phase and m-T/Cirrus 715 alloy (50/50) were prepared in a substantially similar manner as that used for example 1.

a) Preparation of Sulfonyl Urea Developer/NIR Dye Alloy.

94 g of N-p-Tolylsulfonyl-N′-3-(p-tolylsulfonyloxy)phenylurea were heated until complete melting (˜180C). 6 g of IR780 NIR dye (3H-Indolium, 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propyl-, iodide (9C)—(available from “Aldrich”, the dye structure is presented in Formula VII) were mixed into the melt. The melt was cooled down to 140° C. and stirred until complete dissolution of the NIR dye.

Then the melt was cooled down to a solid, glassy state and milled in aqueous dispersion (˜15% solids) using Netzsch Mini-Zeta Bead mill with 1.5 mm zirconia beads. The milling was stopped when average particle diameter was reduced to a value of about 1.0 μm to about 1.6 μm. The particles in the slurry were collected and freeze-dried. 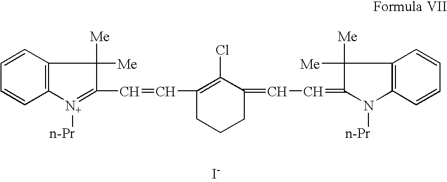
b) Preparation of the UV-Curable Developer Phase

About 13 g of the milled sulfonyl urea Developer/NIR Dye Alloy powder, 1.55 g of m-T/Cirrus 715(50:50) Alloy, 2.43 g of (Bis(2-methyl-4-hydroxy-5-tert-butylphenyl) sulfide (available from TCI America) and 6.62 g of Irgacure-1330 (available from Ciba Specialty Chemicals) were dissolved/dispersed in 51.5 g XP155-049/10 UV-lacquer (available from Nor-Cote International) to form the lacquer/antenna/developer solution or IR(780 nm)-sensitized/UV-curable developer phase.

c) Preparation of Color Forming Composition (Fine Dispersion)

A UV-curable paste was prepared by mixing (a) about 25 g of the finely milled color former particles with (d) about 75 g of the UV-curable developer phase. The paste was screen printed onto a substrate at a thickness of approximately about 6 μm to about 8 μm to form an imaging medium including an imaging coating. The coating on the medium was then UV cured by mercury lamp. The resulting coating was transparent with a noticeable dark-yellowish-green hue. Direct marking on the UV cured imaging coating was carried out using a 45 mW laser having a wavelength of about 780 nm. A mark of approximately 20 μm by 45 μm was produced using various durations of energy application from about 15-20 μsec to about 100 μsec. Upon application of appropriate energy, the color forming composition of the imaging coating changed in color from the yellowish-green transparent appearance to a black color.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

1. A color forming composition, comprising:
at least one color former;
at least one sulfonamide developer; and
a radiation absorber that absorbs electromagnetic radiation and generates heat that causes selective combination of said color former and sulfonamaide developer.

2. The composition of claim 1, wherein said developer comprises sulfonyl urea.

3. The composition of claim 1, wherein said developer includes at least one of
R1SO₂NHXNHABR2 [R1=(substituted) Ph, naphthyl, or C₁₋₂₀ alkyl; X═CNH, CS, or CO; A=(substituted) phenylene, maphthylene, or C₁₋₁₂ alkylene or a divalent heterocyclic group; B═OSO₂, SO₂O, NHSO₂, SO₂NH, SSO₂, OCO, OCONH, NHCO, NHCO₂, SCONH, SCSNH, CONHSO₂, OCONHSO₂, NH═CH, CONHCO, S, CO, O, SO₂NHCO, OCO₂, or OPO(OR2)₂; and R2=(substituted) aryl, benzyl, or C₁₋₂₀ alkyl, with the proviso that if B is not OSO₂, R2 is (substituted) Ph, naphthyl, or C₁₋₈, akyl and if B is O, R2 is not alkyl].

4. The composition of claim 1, and further comprising a binder material.

5. The composition of claim 4, wherein said binder includes at least one of polyacrylate, polyvinyl alcohol polyvinylbutryl, cellulose acetate, and cellulose acetate butyrate.

6. The composition of claim 1, wherein said color forming material includes a leuco dye.

7. The composition of claim 6, wherein said leuco dye is a fluoran, a isobenzofuran, or a phtbalide.

8. A radiation image-able composition, comprising:
a polymeric activator phase including a polymer matrix and an sulfonamide developer dissolved therein;
a color former phase including a color former: and
a radiation absorber that absorbs electromagnetic radiation and generates heat that causes selective combination of said color former and sulfonamide developer.

9. The composition of claim 8, wherein said developer comprises sulfonayl urea.

10. The composition of claim 8, wherein said radiation image-able composition has a pre-development state and a post-development state, said pre-development state having an appearance that is visually different than said post-development state.

11. The composition of claim 8, wherein said polymer matrix includes a radiation curable polymer.

12. The composition of claim 11, wherein said radiation curable polymer is curable at a curing wavelength that is different than a developing wavelength which would cause said radiation image-able composition to change or develop color.

13. The composition of claim 12, wherein said curing wavelength is in an ultraviolet range

14. The composition of claim 12, wherein said developing wavelength is in an infrared range.

15. The composition of claim 12, wherein said developing wavelength is from about 200 nm to about 1200 nm.

16. The composition of claim 8, wherein said polymeric activator phase further comprises an aromatic stabilizer.

17. The composition of claim 16, wherein said aromatic stabilizer is configured to stabilize said color former in the post-development state.

18. The composition of claim 8, wherein said radiation absorber is dispersed or dissolved within said polymeric activator phase.

19. The composition of claim 8, wherein said radiation absorber is dispersed or dissolved within said color former phase.

20. The composition of claim 8, wherein a first portion of said radiation absorber is dispersed or dissolved within said polymeric activator phase, and wherein a second portion of said radiation absorber is dispersed or dissolved within said color former phase.

21. The composition of claim 9, and further comprising a binder material.

22. The composition of claim 21, wherein said binder includes at least one of poly acrylate, polyvinyl alcohol polyvinylbutryl, cellulose acetate, and cellulose acetate butyrate.

23. A method of forming a color forming composition, comprising:
preparing a color former phase;
preparing a polymer matrix;
dissolving a sulfonamide developer in said polymer matrix to form a polymeric developer phase;
combining said color former phase and said polymeric developer phase; and
providing a radiation absorber in thermal communication with at least one of said color former phase and said developer phase wherein radiation absorber absorbs electromagnetic radiation and generates heat that causes selective combination of said color former phase and sulfonamide developer.

24. The method of claim 23, wherein said developer comprises sulfonyl urea.

25. The method of claim 23, further comprising preparing a binder and combining said binder, said sulfonamide developer, and said polymeric matrix to form said polymeric developer phase.

26. A method of forming an image, comprising: applying electromagnetic radiation to radiation absorbing molecules in a color forming composition to heat said radiation absorbing molecule said heat causing selective mixture of a sulfonamide developer and a color former of said composition sufficient to selectively develop the color forming composition from a pre-development state to a post-development state that is visually different than the pre-development state, said color forming composition including a polymeric activator phase including a polymer matrix and said sulfonamide developer dissolved therein.

27. A method as in claim 26, wherein the electromagnetic radiation is applied for a duration and at an energy level such that the color forming composition does not decompose.

28. The method of claim 26, wherein said electromagnetic radiation is laser energy.

29. The method of claim 26, wherein said electromagnetic radiation is applied at from about 0.05 J/cm² to about 5 J/cm².

30. The method of claim 26, wherein said electromagnetic radiation is applied fox about 15 μsec to about 200 μsec.

31. The method of claim 26, wherein said electromagnetic radiation is applied at a spot size from about 10 μm to about 60 μm.

32. The method of claim 26, wherein said electromagnetic radiation is applied at a power level from about 15 mW and about 100 mW.

33. The method of claim 26, wherein said electromagnetic radiation has a wavelength from about 200 nm to about 1200 nm.

34. The method of claim 26, further comprising a preliminary step of applying said color forming composition to a substrate.

35. The method of claim 34, wherein said substrate includes an optical disk.

36. The composition of claim 1, wherein said radiation absorber also absorbs electromagnetic radiation to facilitate curing of a matrix associated with said composition.

37. The composition of claim 36, wherein said matrix comprises a polymer.

38. The composition of claim 1, wherein said developer is present in said color forming composition as a whole at from 1 wt % to about 40 wt %.

39. The composition of claim 1, wherein said color former is disposed in a color former phase that further comprises a melting aid.

40. The composition of claim 39, wherein said melting aid comprises a crystalline organic solid.

41. The composition of claim 39, wherein said melting aid comprises about 2 wt % to about 25 wt % of said color former phase.

42. The composition of claim 1, wherein said radiation absorber is present in both a color former phase comprising said color former and a developer phase comprising said developer.

43. The composition of claim 1, wherein said radiation absorber is a separate layer from said color former and said developer.
